(19) United States
(12) Patent Application Publication
(10) Pub. No.: US 2016/0314258 A1
(43) Pub. Date: Oct. 27, 2016

(54) METHOD AND SYSTEM FOR DETERMINING WHETHER A PATIENT HAS MOVED OR BEEN MOVED SUFFICIENTLY TO PREVENT PATIENT BEDSORES

(71) Applicant: CERNER INNOVATION, INC., KANSAS CITY, KS (US)

(72) Inventor: NEIL KUSENS, SHERMAN OAKS, CA (US)

(21) Appl. No.: 15/134,189

(22) Filed: Apr. 20, 2016

Related U.S. Application Data
(60) Provisional application No. 62/150,523, filed on Apr. 21, 2015.

(51) Int. Cl. G06F 19/00; G08B 25/01; H04N 13/02; G08B 21/04; H04N 7/18; G06K 9/00

(52) U.S. Cl. CPC G06F 19/3406; H04N 7/181; G06K 9/00342; G06K 9/00711; H04N 13/0242; G08B 21/0438; G08B 25/016; G06K 2009/00738

(57) ABSTRACT

A computerized system for preventing bedsores may use a 3D motion sensor and computerized monitoring system to detect changes in patient position consistent a bedsore prevention plan. A communication subsystem may be used to issue alerts to patients and/or caregivers if a predetermined time period elapses without detectable bedsore prevention actions.

### CROSS-REFERENCE TO RELATED APPLICATIONS

This application claims the benefit of U.S. Provisional Patent Application No. 62/150,523, filed on Apr. 21, 2015, which is hereby incorporated by reference in its entirety.

### TECHNICAL FIELD

This disclosure relates to systems and methods for determining whether a patient has moved or been moved sufficiently to prevent patient bedsores.

### BACKGROUND

Bedsores, also called pressure sores or pressure ulcers, are skin and tissue injuries from prolonged pressure applied to the skin. Bedsores most commonly develop on the skin covering bony parts of the body, such as hips, heels, and ankles. Bedsores are a significant threat to patients with a medical condition which limits their ability to change position, such as a patient confined to a bed for an extended period of time. Bedsores can develop quickly and become a severe health issue requiring costly treatment. The medical facility must typically bear the cost of bedsores, which puts a strain on the finances of the healthcare provider. It is typically far less expensive to prevent bedsores than it is to treat bedsores.

Bedsores may be prevented by changing a patient's position frequently in order to avoid prolonged pressure and stress being placed on vulnerable areas. Bedsore prevention plans may vary based on the circumstances of the patient, however, a typical recommendation is to change a patient's position at least every two hours.

### BRIEF SUMMARY

This disclosure generally relates to a computerized system for monitoring a patient, to ensure the patient changes position with sufficient frequency to reduce the probability that the patient will develop (or maintain, or aggravate) bedsores.

In some aspects, a method for reducing the probability that a patient will develop a bedsore is disclosed. The method may comprise receiving, by a computerized monitoring system, electronic data from one or more 3D motion sensors positioned within a room with a patient. The method may comprise detecting, by the computerized monitoring system, when the patient has changed position consistent with patient bedsore prevention actions, based on the electronic data. The method may comprise determining, by the computerized monitoring system, if the patient has not sufficiently changed position within a predetermined period of time.

The method may comprise sending an alert to a caregiver if the patient has not changed positon consistent with patient bedsore prevention actions within the predetermined period of time. The method may comprise programming the one or more 3D motions sensors to lock on to the patient. The method may comprise capturing live video data from a monitored area around the patient. The method may comprise displaying a live video feed of the monitored area on a central monitoring primary display.

The method may comprise receiving live video feed from one or more 3D motion sensors by a central monitoring primary display remote from the monitored area. The method may comprise displaying a live video feed of the monitored area on a centralized monitoring alert display if it has been determined that the patient has not sufficiently changed position consistent with patient bedsore prevention actions within a predetermined period of time. The central monitoring alert display may be a separate display from the central monitoring primary display. The live video feed may be continuous. The method may further comprise updating a database in communication with the computerized monitoring system regarding the determination of whether the patient has sufficiently changed position consistent with patient bedsore prevention actions within a predetermined period of time.

In some aspects, a system for reducing the probability that a patient will develop a bedsore is disclosed. The system may comprise one or more 3D motion sensors located in a room with a patient. The system may comprise a computerized monitoring system in electronic communication with at least one of the one or more 3D motion sensors. The computerized monitoring system may be configured to receive and analyze data from the one or more 3D motion sensors. The system may comprise a central monitoring station in electronic communication with the computerized monitoring system. The central monitoring station may comprise a primary display and an alert display. The system may comprise a communication system in electronic communication with at least one of the computerized monitoring system and the central monitoring station. The communication system may be configured to provide human-intelligible messages to the patient and/or a caregiver for the patient. The system may comprise a database in electronic communication with at least one of the one or more 3D motion sensors, the computerized monitoring system, the central monitoring station, and the communication system.

The one or more 3D motion sensors may be programmed to lock on to the patient. The one or more 3D motion sensors may provide data in the form of a live video feed to the computerized monitoring system. The computerized monitoring system may be programmed to analyze a subset of the live video feed to detect when the patient has changed position consistent with patient bedsore prevention actions, based on the electronic data. The computerized monitoring system may be programmed to determine whether the patient has not sufficiently changed position consistent with patient bedsore prevention actions within a predetermined period of time. Upon determining that the patient has not changed position consistent with patient bedsore prevention actions consistent with bedsore prevention actions within a predetermined period of time, the computerized monitoring system may communicate the determination to at least one of the communication system and the central monitoring station. The computerized monitoring system may communicate the determination to the communication system, and the communication system may send an alert to the patient. The computerized monitoring system may communicate the determination to the central monitoring station, and, upon receiving the determination, a video feed from the one or more 3D motion sensors associated with the determination is moved from the central monitoring station primary display to the central monitoring alert display. The determination may be communicated by at least one of the computerized monitoring system, the communication system, and the central monitoring station, to a database. Upon determining that the patient has changed position consistent with bedsore prevention actions, the computerized monitoring station may reset the predetermined time.

Additional objects, advantages, and novel features of the disclosure will be set forth in part in the description which follows, and in part will become apparent to those skilled in the art upon examination of the following, or may be learned by practice of the disclosure.

### BRIEF DESCRIPTION OF THE DRAWINGS

The present disclosure references the attached drawing figures, wherein:

FIG. 1 is an exemplary workflow for monitoring bedsore prevention actions in accordance with aspects of the disclosure;

FIG. 2 is an exemplary workflow for centralized monitoring and alerting in accordance with aspects of the disclosure; and

FIG. 3 is a schematic view of an exemplary computing system in accordance with aspects of the disclosure.

### DETAILED DESCRIPTION

Bedsore prevention typically involves changing a patient's position, so that the patient's weight is borne by different parts of the body over time. For generally healthy individuals, this is not typically a problem even if the person is confined to bed for a few days due to acute injury or illness, because the person will likely self-reposition due to discomfort before there is skin or tissue injury like a bedsore. Patients with limited mobility, altered consciousness, or other conditions, whether temporary or chronic, might not be fully aware of the discomfort that typically prompts a patient to self-reposition, or may be physically unable to self-reposition even in response to discomfort or pain. Bedsore prevention plans typically involve repositioning the patient on a regular schedule, such as once at least every two hours. The duration for which a patient may be allowed to remain in one position is approximate, and the durations between repositioning over the course of a day or more may vary.

Although bedsore prevention is more desirable than bedsore treatment both for patient experience and for reducing healthcare costs, consistently executing a bedsore prevention plan can be challenging. Bedsore prevention plans typically include repetitive tasks, which can make it difficult for a patient or caregiver to remember when the task was last completed. Repositioning may be uncomfortable for the patient and/or physically strenuous for the caregiver, making it undesirable to reposition the patient more often than is necessary. If a patient is mobile or semi-mobile, the patient may self-reposition. This could lead to a caregiver repositioning a patient back to a recent prior position, defeating the purpose of the repositioning. During peak periods of activity, a caregiver, for example, a caregiver with responsibility for multiple patients, other people (such as children), or other tasks, may forget to reposition the patient or may be unavailable to reposition the patient due to competing demands. In some instances, a caregiver may enter a patient's room with the intent to reposition the patient, and become engrossed in tending to other needs of the patient. For these or other reasons, even a diligent caregiver may fail to follow a bedsore prevention plan for a patient.

The systems, methods, and media of this disclosure may help a patient, a caregiver, or others determine whether a patient has moved or been moved sufficiently to prevent bed sores. The sufficiency may relate to the number of times the patient is repositioned, or the duration of time elapsed between changes in position, or the magnitude of change in the patient's position, or combinations thereof. In some aspects, the systems, methods, and media may include means for communicating with the patient, a caregiver, and/or others if the patient has not moved sufficiently to prevent bed sores. The computerized systems and methods may, once configured, operate largely or entirely independently of a human operator. A human operator may be necessary only to respond to alerts generated by the computerized systems and methods.

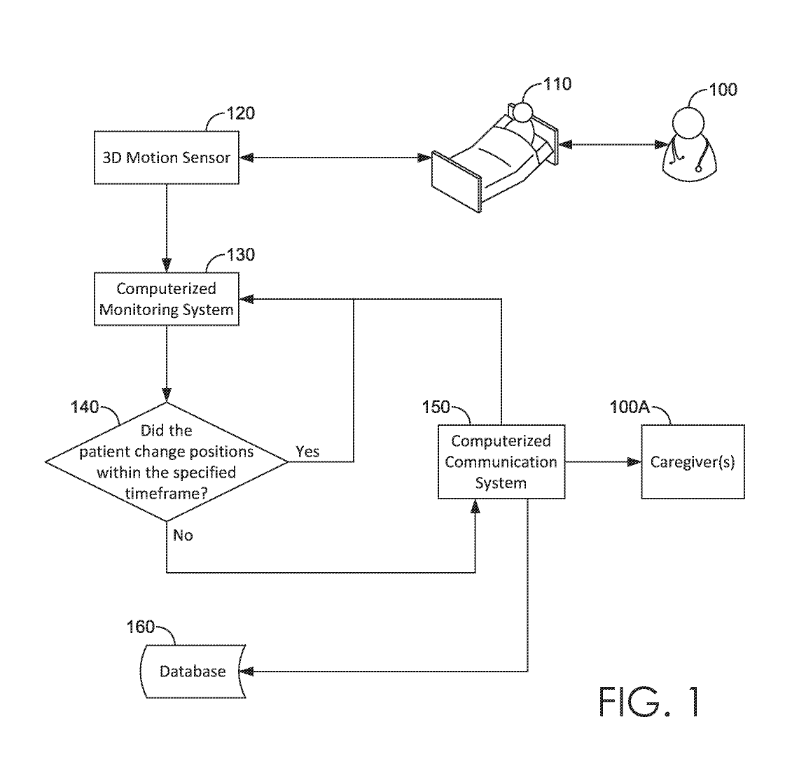

FIG. 1 shows an exemplary workflow for monitoring whether a patient has moved or been moved sufficiently to prevent bed sores. As shown, caregiver 100, may interact with a patient 110. The caregiver may be a medical provider, such as a nurse, nurse's aide, medical technician, nurse practitioner, physician's assistant, physician, physical therapist, chiropractor, massage therapist, or the like. The caregiver may be a family member or friend, or an assistant who might or might not be a medical provider, or anyone else who might assist the patient with moving or repositioning. The patient may be an in-patient in a medical facility, such as a hospital, rehabilitation facility, hospice care facility, surgical center, or the like, or the patient may be in an outpatient medical facility, or a group living facility, or a home, or the like. The patient may be confined to bed, but could also be at risk of bed sores from prolonged contact with other surfaces, such as chairs, chaises, stretchers, examination tables, treatment tables, surgical tables, wheelchairs, etc., or combinations thereof. As used in this disclosure, the term “patient” distinguishes a person being monitored from others who may be within range of the monitoring sensors, such as visitors, caretakers, other service providers, passers-by, and the like.

Wherever the patient is, a 3D motion sensor 120 may be co-located with the patient, such as in the same room as the patient. The 3D motion sensor 120 may be positioned to have a view of most or all of the patient's body. In general, the 3D motion sensor is an electronic device that contains one or more cameras and, optionally, one or more microphones, capable of identifying individual objects, people, and motion, regardless of lighting conditions. As used in this disclosure, unless expressly described as an array of two or more sensors, reference to a sensor or sensors encompasses the singular and the plural, e.g., a singular sensor or an array of sensors, and an array of sensors may be physically housed in a unitary structure or may be physically distinct devices. The cameras may utilize technologies including, but not limited to, color RGB, CMOS sensors, lasers, infrared projectors and RF-modulated light. The 3D motion sensor 120 may contain one or more microprocessors and/or image sensors to detect and process information both transmitted and received by the 3D motion sensor 120. Suitable 3D motion sensors can perceive depth, in contrast to 2D cameras which perceive only lateral and longitudinal positions. Exemplary 3D motion sensors include the Microsoft® Kinect® Camera, the Sony® Playstation® Camera and the Intel® RealSense® Camera, each of which happens to include one or more microphones, although sound capture is not essential to the practice of all aspects of the disclosure.

The 3D motion sensor 120 may be in electronic communication with a computerized monitoring system 130, either as a separate component of the same physical unit or device, or as separate devices. The 3D motion sensor 120 may be co-located with or remote from computerized monitoring system 130, so long as data can be sent by the 3D motion sensor 120 to the computer monitoring system 130 or retrieved by the computerized monitoring system 130 from the 3D motion sensor 120.

The 3D motion sensor 120 may operate continuously, or intermittently (for example, running for a fixed period at defined intervals), or on a trigger (e.g., when a motion detector or light sensor is activated, suggesting activity in the room). The 3D motion sensor 120 may operate continuously at all times while the monitoring is occurring, regardless of whether the person or object of interest is moving or not. The 3D motion sensor 120 preferably views the entire room or a large portion of the room by placement in a manner sufficient for the room to be visible to the camera. The 3D motion sensor 120 may record video. Video is a series of sequential, individual picture frames (e.g., 30 frames per second of video). In some implementations, it may be desirable for the sensors to capture video only, or sound only, or video and sound. Video only may make monitored patients more comfortable having conversations with visitors or caregivers than if sound is also captured. Alternatively, or additionally, to protect patient privacy and modesty, video displays of the image data from the 3D motion sensor may be blurred or pixelated or otherwise obscured, or the people and objects in the room may be converted from detailed image data to cartoons, less detailed drawings, or stick figures when displayed. The 3D motion sensor may collect data sufficient for measuring movement and interaction between different people within the room, but transmit only sufficient data for a partially obscured video, or a microprocessor associated with the 3D motion sensor and/or computerized monitoring station may process image and/or video data to make the individuals and/or details of the room or the activity of the room more difficult to distinctly identify.

The computerized monitoring system 130 may receive and analyze data from 3D motion sensor 120. The computerized monitoring system 130 and/or the 3D motion sensor 120 may be configured to monitor and/or analyze only a portion of the full view of the 3D motion sensor 120. For example, 3D motion sensor might be capable of viewing an entire room, or a room and part of an adjacent hallway. However, to reduce processing capacity and communication bandwidth requirements, the 3D motion sensor 120 may be configured to capture data from a limited view, and/or the computerized monitoring system 130 may be configured to analyze only a portion of the data from 3D motion sensor 120. For example, the computerized monitoring system 130 may capture data from a pre-defined area around a patient, or around a patient's bed or chair. Exemplary processes for configuring the system in this manner are disclosed in U.S. patent application Ser. No. 14/757,877, filed on Dec. 24, 2015, and U.S. patent application Ser. No. 14/613,866, filed Feb. 4, 2015, which is each hereby incorporated by reference in its entirety.

Computerized monitoring system 130 is specifically designed and programmed to monitor activity based on information received from 3D motion sensor 120. Computerized monitoring system 130 may use facial recognition, height, distance between body points, etc. to “lock onto” the patient for analysis, helping to avoid the possibility of the computerized monitoring system 130 tracking a visitor or caregiver who might pass between the patient and the 3D motion sensor, or others who may enter the 3D motion sensor's field of view. Alternately, or in addition, 3D motion sensors and/or additional sensors, such as an RFID reader, may read an electronic receiver, transmitter, or transceiver associated with the patient and/or with a caregiver to identify and/or distinguish individuals in the room. The patient and/or the caregiver may wear, carry, or otherwise be associated with such a transceiver in the form of a badge, token, bracelet, cell phone, or other device. As one example, the patient may wear, carry, or otherwise be associated with a transmitter and the caregiver may wear, carry, or otherwise be associated with a receiver. Alternately, the patient may wear, carry, or otherwise be associated with a receiver and the caregiver may wear, carry, or otherwise be associated with a transmitter. Or both the patient and the caregiver may wear, carry, or otherwise be associated with a transmitter or a receiver or both.

Computerized monitoring system 130 may use skeletal tracking, blob tracking, or other image recognition techniques to identify one or more tracking points on the patient's body, such as hips, shoulders, knees, chin, nose, etc. The patient's position can then be analyzed by tracking skeletal segments, or the shape and orientation of a blob, or specified tracking points. For example, the system may identify or infer the position of the patient's right knee at a time designated as T1, as by the coordinates (x1, y1, z1) of the patient's right knee in a picture frame. At a later time T2, the patient's right knee might be at coordinates (x2, y2, z2). Based on this information, motion, speed and direction of movement (or lack of movement) can be derived utilizing the elapsed time and comparing the two 3D coordinates. As opposed to conventional motion sensors, which use captured motion to control a camera, the 3D motion sensor used in the methods and systems described herein is used to computer the motion. Further, a 3D motion sensor, as opposed to a 2D motion sensor, offers depth sensitivity that can help to reduce false alarms (e.g., by identifying rotational or vertical movement, as might occur when a patient rolls to or from one side of the body), as well as help to isolate the analysis to the patient and avoid false alarms or false confirmations of repositioning from other objects or individuals who might pass in front of or behind the patient.

A minimum degree of change may be specified as a threshold for the computerized monitoring system 130 to determine that a patient has changed position. The degree of change may be specified in distance (e.g., the patient's right hip must move at least 9 cm before concluding that the patient has changed positions), or angular movement, or a combination thereof. It should be appreciated that in this regard, changing position refers to a movement or repositioning consistent with a bedsore prevention action. Not all movement will be a change in position in this regard. Computerized monitoring system 130 may distinguish movements which are not likely to indicate a change in position consistent with a bedsore prevention action, such as movement of the hands, arms, or head, from movements which are likely to indicate a change in position consistent with a bedsore prevention action, such as movement of the hips and/or shoulders. Computerized monitoring system 130 may reduce the likelihood of mistakenly identifying small or peripheral movements from a change in position consistent with a bedsore prevention action by the choice of body locations monitored (e.g., hips, shoulders, torso as compared to hands or feet) or by evaluating the relation of two or more body parts. Computerized monitoring system 130 may use body part segmentation, e.g., the identification of skeletal segments between joints, to distinguish a hand or foot from a leg or hip. In some embodiments, the data analyzed to evaluate whether a patient has changed position may be a subset of the data provided by the 3D motion sensor. For example, the 3D motion sensor may collect, transmit, and/or otherwise make available to computerized monitoring system 130 data for an entire room, or for a volume around the patient's bed, or for most or all of the patient's body, but for the purpose of determining whether a patient has changed position consistent with a bedsore prevention action, the computerized monitoring system 130 may analyze only data from the patient's torso, possibly including the hips and/or shoulders. In this manner, the computerized monitoring system 130 may focus on parts of the body, such as the torso, which, when reoriented or repositioned generally reflect a significant change in the orientation and/or position of the body as a whole, in contrast to body parts like the hands and feet, which might move without any corresponding change in the orientation and/or position of the body as a whole, or without any significant corresponding change in the orientation and/or position of the body as a whole.

For example, a supine patient could move her left arm from her left side across her body toward her right side without changing, or without significantly changing, where her body weight is creating pressure points against the bed or furniture she is lying on. Similarly, a supine patient might move from one side of the bed to the other, resulting in a change in the x-coordinate for the position of her right shoulder, but remain in a supine position without significantly changing the pressure points on the back of her body. However, if a supine patient's right shoulder moves several inches to the left and her left arm moves from her left side toward her right side, the probability increases that she has rolled from her back onto or toward her right side, which would change where her body contacts the bed, and would generally be consistent with a bed sore prevention action. This relational comparison increases the likelihood that the movement is consistent with a bed sore prevention action compared to evaluating only the arm position or only the shoulder position. As another example, a supine patient might turn his face from left to right or vice versa without significantly changing the contact points between his body and the bed. However, if the supine patient's face turns from upright to the left and the patient's right hip elevates, the probability increases that he has rolled toward or onto his left side, which would change where his body contacts the bed, and would generally be consistent with a bed sore prevention action. A patient may change position by moving or self-repositioning, by being moved or repositioned, by changing or shifting position, or by being rolled, rotated, shifted, or otherwise repositioned consistent with bedsore prevention actions.

Computerized monitoring system 130 may analyze a patient's position over a specified time frame. A default amount of time for bedsore prevention activities may, for example, be 2 hours. The specified time period might be somewhat shorter, for example, 1 hour and 45 minutes, so that if the patient is not moved within the specified time, an alert is sent out while there is still time to reposition the patient in compliance with a bedsore prevention plan to reposition the patient every 2 hours. The specified time period could also be extended or reduced by a patient, caregiver, or other system user, for example, for a patient who is at somewhat higher or lower risk of bedsores. For example, a patient with existing bedsores might be repositioned more or less frequently, to avoid aggravating existing bedsores and/or to prevent the formation of new bedsores on different body parts.

If computerized monitoring system 130 determines that the patient has changed position within a given timeframe, shown as decision 140 in FIG. 1, computerized monitoring system 130 may reset a timer for evaluating whether a patient has changed position, now measuring whether the patient is again repositioned from the second position within a specified time frame. Computerized monitoring system 130 may further record a determination that the patient has changed position, for example, in database 160.

If the computerized monitoring system 130 determines that the patient has not changed position within the specified time frame, computerized monitoring system 130 may send that determination to computerized communication system 150. Computerized communication system 150 may be a subsystem of computerized monitoring system 130, or may be implemented as independent software, firmware, and/or hardware. Computerized communication system 150 may include or may be communicatively coupled to one or more of amplified speakers, microphones, lights, monitors, computer terminals, mobile phones, pagers, and/or other technologies to facilitate communication with one or more human system users.

Upon receiving a determination that a patient has not changed position consistent with bedsore prevention actions from computerized monitoring system 130, computerized communication system 150 may alert the patient, one or more caregivers, or others, that the patient has not been repositioned within the specified timeframe. The alert may be any human-intelligible signal suitable for communicating a change in status (e.g., compliant with bedsore prevention plan to non-compliant with bedsore prevention plan, or vice versa) or request for attention. For example, computerized communication system 150 may send an alert to a speaker, public announcement system, television, monitor, cell phone, computer, or other display device in a patient's room. The alert, which could be audible or visible or both, may request that the patient roll over or remind the patient that it is time to change position. The alert could be text or sound, or could consist of flashing lights in the room or on a display, or another visible change in the patient's room, such as a change in the color of a border of a monitor or television, or a change in the brightness or color of the light in the room. Alerts to the patient may be disabled, for example, if the patient is known to be unable to self-reposition without assistance.

In addition to or instead of alerting the patient, computerized communication system 150 may alert one or more caregivers 100A. As with alerts intended for a patient, alerts for a caregiver could be audible or visible or both, and may include text alerts, instructions, or other signals that something is amiss, e.g., flashing lights, color schemes, etc. An alert for a caregiver may be sent to the patient's room, or may be sent to a device carried by the caregiver, such as a cell phone or pager, or may be sent to a nursing station or dispatch center. An alert for a caregiver may be sent to a primary caregiver, and, if no change is detected within a predetermined response time, an alert may be sent to one or more additional caregivers. Alternately, an alert may be sent to two or more caregivers at the outset. Alerts may also be sent to others who might not have primary responsibility for the care of the patient, such as family members or guardians. Alerts, possibly including the 3D motion sensor data in the time period before the alert and/or any response(s) to the alert, may be recorded, for example, in database 160. Exemplary responses may include a system determination that the patient has changed position consistent with bedsore prevention actions since the alert, or a human operator cancelation of the alert (e.g., based on a caregiver or central monitoring station attendant confirmation that the patient has changed position or for some reason should not change position at this time).

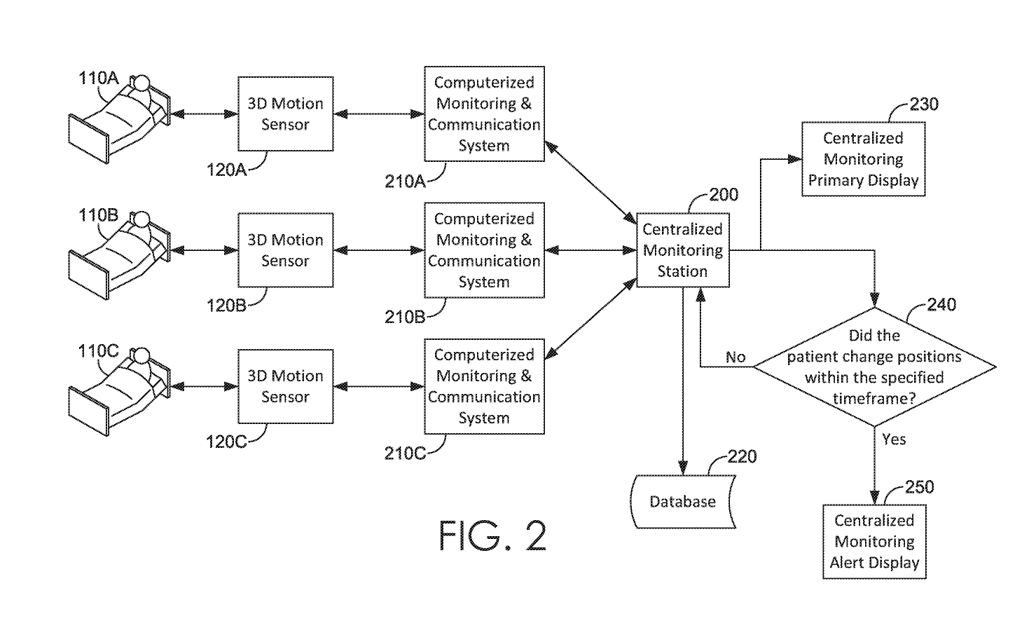

Computerized monitoring system 130 and/or computerized communication system 150, shown in FIG. 2 as combined computerized monitoring and communication systems 210A, 210B, and 210C, may also be in communication with a central monitoring station 200. A central monitoring station 200 may be used with a single 3D motion sensor 120 for a single patient. For example, central monitoring station 200 may include a display in a home of a family member or guardian of patient 110. As shown in FIG. 2, a plurality of 3D motion sensors 120A, 120B, and 120C may monitor a plurality of patients, 110A, 110B, and 110C, respectively. The 3D motion sensors 120A, 120B, and 120C may be monitored by distinct computerized monitoring and communication systems 210A, 210B, and 210C. Alternately, 3D motion sensors 120A, 120B, and 120C could each send 3D motion and/or sound data to a single computerized monitoring system 130.

The computerized monitoring system 130 and/or computerized monitoring and communication systems 210A, 210B, and 210C may send filtered or unfiltered data, such as images and/or a live video feed, with or without sound, from 3D motion sensors 120A, 120B, and 120C to central monitoring station 200. The 3D motion sensor data may be received and displayed on a central monitoring primary display 230, which may be a single display monitor or a series or grid of two or more display monitors. As mentioned above, the computerized monitoring system and/or the central monitoring station may apply filters before the 3D motion sensor data is displayed, for example, to blur or pixelate the face or body of the patient, to protect patient privacy. In addition, video and/or sound, if sound is provided, can be turned off at any node, including central monitoring primary display 230, to protect patient privacy, e.g., while the patient is receiving visitors, bathing, changing clothes, etc. If a large number of patients are being monitored at the same time, the central monitoring primary display 230 may be enlarged so that it can aggregate additional telemetry feeds, or more than one central monitoring station primary display 230 could be used. Regardless of whether the data is filtered or unfiltered, it may still be processed by the computerized monitoring system 130, a computerized monitoring and communication system (e.g., 210A, 210B, or 210C) and/or the central monitoring station 200 to render the data as a human-intelligible visual image or series of images (e.g., video).

When the computerized communication system receives an alert, the computerized communication system may send the alert to the central monitoring station 200. At step 240, on receipt of a determination from the computerized monitoring system 130 and/or an alert from the computerized communication system 150 for a particular 3D motion sensor, the display from that sensor is moved from central monitoring station primary display 230 to central monitoring station alert display 250 or duplicated on central monitoring station alert display 250. Central monitoring station alert display 250 may be a subset of the display or displays of central monitoring station primary display 230, or may be a distinct display or series of displays. If live video is available but was not being displayed on central monitoring station primary display 230, the live video may be displayed on central monitoring station alert display 250 after an alert is received. Central monitoring station alert display 250, or an attendant there, may analyze the video feed to determine what is happening in the patient's room. If a caregiver has arrived and is repositioning the patient, the central monitoring station alert display 250 or attendant may clear the alert. If an alert has been sent to a caregiver and no response is detected or received, central monitoring station alert display 250 or an attendant may notify an alternate or back-up caregiver that the patient needs assistance with repositioning. Alerts and any actions taken or responses received or observed at central monitoring station 200 may be recorded, for example, to database 160.

The central monitoring station primary display 230 may routinely display live video for monitored patients. An attendant at the central monitoring station primary display 230 can use the live video feed to detect other problems, such as a patient fall, a patient gesture that he or she needs assistance, an unauthorized person has entered the patient's room, etc.

The various system components and/or method steps may be situated and/or performed remotely from one another. So long as the components can transfer data and perform the functions described, the components or any subcombination of components could be located together, even, in some aspects, in a singular physical housing. Alternately, the components or any subcombination of components could be remote from one another, either in different rooms, different floors of a building, different buildings, different cities, or even different countries or continents. The central monitoring station 200, for example, may reside at a nursing station on the same floor or on a different floor of the same building as the 3D motion sensor, or could be in a regional center that receives telemetry from a plurality of 3D motion sensors in different rooms, buildings, or even cities, and possibly in a variety of patient environments. That is, a computerized monitoring system, computerized communication system and/or central monitoring station may process data from 3D motion sensors in hospitals, outpatient centers, assisted living facilities, and/or private homes, or may be specific, e.g., to a particular patient, healthcare organization (such as a hospital or hospital network).

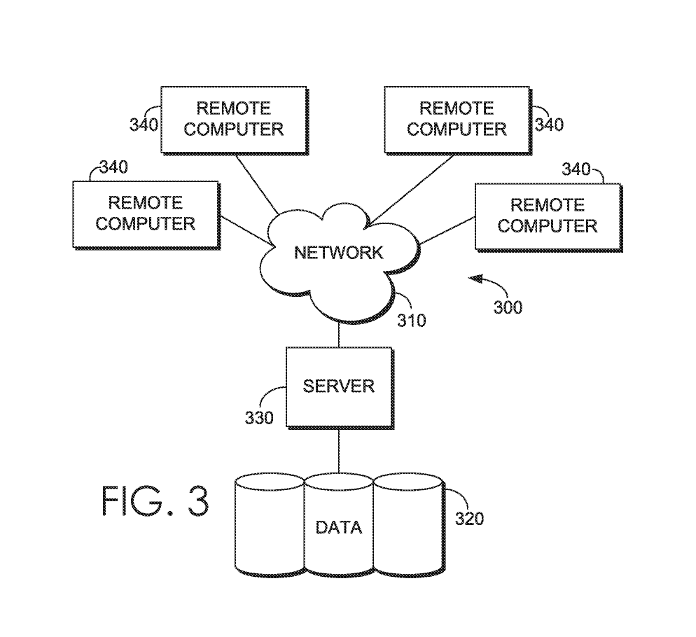

The systems, method, and media described may be operated in an exemplary computing environment 300 as shown in FIG. 3. Exemplary computing environment 300 includes at least one general purpose computing device in the form of a control sever 330. Components of control server 330 may include, without limitation a processing unit, internal system memory, and a suitable system bus for coupling various system components, including database cluster 320, with the control server 330. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus.

The control server 330 typically includes therein, or has access to, a variety of computer-readable media, for instance, database cluster 320. Computer-readable media can be any available media that may be accessed by control server 330, and includes volatile and nonvolatile media, as well as removable and non-removable media. By way of example, and not limitation, computer-readable media may include computer-storage media and communication media. Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 330. Computer-storage media may exclude signals per se. Computer-readable media may exclude signals per se.

Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media. The computer-storage media discussed above and illustrated in FIG. 3, including database cluster 320, provide storage of computer readable instructions, data structures, program modules, and other data for the control server 330.

The control server 330 may operate in a computer network 310 using logical connections to one or more remote computers 340. Remote computers 340 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices and the clinician's home or the patient's own home or over the Internet. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 340 may also be physically located in non-traditional medical care environments so that the entire health care community may be capable of integration on the network. The remote computers 340 may be personal computers, servers, routers, network PCs, peer devices, other common network nodes, or the like, and may include some or all of the elements described above in relation to the control server 330. The devices can be personal digital assistants or other like devices. As described above, one or more of the remote computers 340 may be specifically designed and/or configured to perform certain functions in relation to the systems and methods disclosed, distinguishing those devices from general purpose computers.

Exemplary computer networks 310 may include, without limitation, local area networks (LANs) and/or wide area networks (WANs). Such networking environments are commonplace in offices, enterprise-wide computer networks, intranets, and the Internet. When utilized in a WAN networking environment, the control server 330 may include a modem or other means for establishing communications over the WAN, such as the Internet. In a networked environment, program modules or portions thereof may be stored and/or executed on the control server 330, in the database cluster 320, or on any of the remote computers 340. For example, and not by way of limitation, various application programs and/or data may reside on the memory associated with any one or more of the remote computers 340. It will be appreciated by those of ordinary skill in the art that the network connections shown are exemplary and other means of establishing a communications link between the computers (e.g., control server 330 and remote computers 340) may be utilized.

In operation, a user may enter commands and information into the control server 330 or convey the commands and information to the control server 330 via one or more of the remote computers 340 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 330. In addition to a monitor, the control server 330 and/or remote computers 340 may include other peripheral output devices, such as speakers and a printer.

Many other internal components of the control server 330 and the remote computers 340 are not shown because such components and their interconnection are well known. Accordingly, additional details concerning the internal construction of the control server 330 and the remote computers 340 are not further disclosed herein.

Methods and systems of embodiments of the present invention may be implemented in a WINDOWS or LINUX operating system, operating in conjunction with an Internet-based delivery system. One of ordinary skill in the art will recognize that the described methods and systems can be implemented in any alternate operating system suitable for supporting the disclosed processing and communications. As contemplated, the methods and systems of embodiments of the present invention may also be implemented on a stand-alone desktop, personal computer, cellular phone, smart phone, PDA, or any other computing device used in a healthcare environment or any of a number of other locations. Nonetheless, when networked and/or programmed as described herein, the system does more than the individual, generic devices could do.

From the foregoing, it will be seen that this disclosure is well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A method for reducing the probability that a patient will develop a bedsore, the method comprising:
receiving, by a computerized monitoring system, electronic data from one or more 3D motion sensors positioned within a room with a patient;
detecting, by the computerized monitoring system, when the patient has changed position consistent with bedsore prevention actions, based on the electronic data; and
determining, by the computerized monitoring system, if the patient has not sufficiently changed position within a predetermined period of time.

2. The method of claim 1, further comprising sending an alert to a caregiver if the patient has not changed position consistent with patient bedsore prevention actions within the predetermined period of time.

3. The method of claim 1, further comprising programming the one or more 3D motion sensors to lock on to the patient.

4. The method of claim 3, further comprising capturing live video data from a monitored area around the patient.

5. The method of claim 4, further comprising displaying a live video feed of the monitored area on a central monitoring primary display.

6. The method of claim 5, further comprising receiving the live video feed from the one or more 3D motion sensors by the central monitoring primary display, wherein the central monitoring primary display is physically remote from the monitored area.

7. The method of claim 5, further comprising displaying a live video feed of the monitored area on a centralized monitoring alert display if it has been determined that the patient has not changed position consistent with patient bedsore prevention actions within a predetermined period of time.

8. The method of claim 7, wherein the central monitoring alert display is a separate display from the central monitoring primary display.

9. The method of claim 7, wherein the live video feed is continuous.

10. The method of claim 1, further comprising updating a database in communication with the computerized monitoring system regarding the determination of whether the patient has changed position consistent with patient bedsore prevention actions within a predetermined period of time.

11. A system for reducing the probability that a patient will develop a bedsore, the system comprising:
one or more 3D motion sensors located in a room with a patient;
a computerized monitoring system in electronic communication with at least one of the one or more 3D motion sensors, the computerized monitoring system configured to receive and analyze data from the one or more 3D motion sensors;
a central monitoring station in electronic communication with the computerized monitoring system, the central monitoring station comprising a primary display and an alert display;
a communication system in electronic communication with at least one of the computerized monitoring system and the central monitoring station, the communication system configured to provide human-intelligible messages to the patient and/or a caregiver for the patient; and
a database in electronic communication with at least one of the one or more 3D motion sensors, the computerized monitoring system, the central monitoring station, and the communication system.

12. The system of claim 11, wherein the one or more 3D motion sensors are programmed to lock on to the patient.

13. The system of claim 12, wherein the one or more 3D motion sensors provide data in the form of a live video feed to the computerized monitoring system.

14. The system of claim 13, wherein the computerized monitoring system is programmed to analyze a subset of the live video feed to detect when the patient has changed position consistent with patient bedsore prevention actions, based on the electronic data.

15. The system of claim 14, wherein the computerized monitoring system is programmed to determine whether the patient has not changed position consistent with patient bedsore prevention actions within a predetermined period of time.

16. The system of claim 15, wherein, upon determining that the patient has not changed position consistent with patient bedsore prevention actions within a predetermined period of time, the computerized monitoring system communicates the determination to at least one of the communication system and the central monitoring station.

17. The system of claim 16, wherein the computerized monitoring system communicates the determination to the communication system, and the communication sends an alert to the patient.

18. The system of claim 17, wherein the computerized monitoring system further communicates the determination to the central monitoring station, and, upon receiving the determination, a video feed from the one or more 3D motion sensors associated with the determination is moved from the central monitoring station primary display to the central monitoring alert display.

19. The system of claim 17, wherein the determination is communicated by at least one of the computerized monitoring system, the communication system, and the central monitoring station, to the database.

20. The system of claim 18, wherein the computerized monitoring station further determines when the patient has sufficiently changed position consistent with patient bedsore prevention actions, and resets the predetermined time upon this determination.
